(19) United States
(12) Patent Application Publication
(10) Pub. No.: US 2012/0046863 A1
(43) Pub. Date: Feb. 23, 2012

(54) ORBIT COVARIANCE, ESTIMATION AND ANALYSIS TOOL

(75) Inventors: Alan Scott Hope, Alexandria, VA (US); Jay W. Middour, Alexandria, VA (US); Jacques Fein, Elkridge, MD (US); Bryan Brown, Silver Spring, MD (US); Patrick Binning, Annandale, VA (US); Peter Melvin, Waldorf, MD (US); Mark Soyka, Round Hill, VA (US); Mark Davis, Edgewater, MD (US)

(73) Assignee: The Government of the US, as represented by the Secretary of the Navy, Washington, DC (US)

(21) Appl. No.: 13/208,368

(22) Filed: Aug. 12, 2011

Related U.S. Application Data
(60) Provisional application No. 61/372,952, filed on Aug. 12, 2010.

(51) Int. Cl. G01C 21/24

(52) U.S. Cl. 701/531

(57) ABSTRACT

Improved orbit/covariance estimation and analysis (OCEAN) system and method are presented utilizing ground station observations collected from satellites passing overhead to estimate the positions, velocities, and other parameters of multiple satellites using weighted least squares (WLS) batch and/or Kalman filter smoothing (KFS) estimation algorithms to estimate each parameter, with or without a priori knowledge of the errors involved with each observed parameter.

### REFERENCE TO RELATED APPLICATION

This application claims priority to and the benefit of U.S. Provisional Patent Application Ser. No. 61/372,952, filed Aug. 12, 2010, entitled “OCEAN-ORBIT COVARIANCE ESTIMATION AND ANALYSIS SOFTWARE”, the entirety of which is hereby incorporated by reference.

### FIELD OF THE DISCLOSURE

The present disclosure relates generally to an apparatus and method for determining parameters (such as position, velocity, ground station location, measurement biases, clock parameters, etc.) associated with one or more satellites and more specifically to an apparatus and method for determining these parameters.

### BACKGROUND

Highly automated, accurate, and reliable orbit determination processing is required for large-scale satellite networks. Reliable automatic processing reduces the cost of operating a satellite network by reducing the need for expert orbit determination personnel. Several general-purpose orbit determination and prediction techniques exist today. However, these techniques are limited in that they do not include: the ability to process raw tracking data, finished orbit products and analyses using a Weighted Least Squares Orbit Determination (WLS-OD) method; the ability to simultaneously compute orbits and covariance for complex networks of multiple satellites; the ability to use multiple ground stations with various tracking measurement types; the ability to compute relative satellite trajectories in which one satellite orbit is determined very accurately with respect to another satellite orbit; the ability to identify calibration anomalies in tracking network components by combining tracking measurements; and the ability to incorporate state-of-the-art dynamical models that allow rapid update to newer models when they become available. Because of this, the following difficulties arise: in the absence of robust automatic operations, skilled orbit analysts must intervene to cull bad observations by manually examining observation errors; most existing orbit determination techniques are designed to process one satellite at a time, requiring large-scale satellite networks to be processed serially; relative navigation requirements are typically addressed by custom program techniques on a case-by-case basis; calibration anomalies have typically been identified by a parametric series of orbit determination computations where sets of parameters are held constant or estimated in a brute force attempt to isolate error sources; and the roots of most orbit determination techniques available today can be traced back to the beginning of the space age. The codes within these techniques are often undocumented, hard to read, and harder to update. Large expenditures are often incurred when model updates are required. This was the basis of the original OCEAN patent.

### SUMMARY OF DISCLOSURE

Various details of the present disclosure are hereinafter summarized to facilitate a basic understanding, where this summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter. Improved orbit/covariance estimation and analysis (OCEAN) systems and methods are provided, which employ ground station observations collected from satellites passing overhead to estimate the positions, velocities, and other parameters of multiple satellites using WLS-OD batch estimation algorithms and/or Kalman filter smoothing (KFS).

In accordance with one or more aspects of the disclosure, a system is provided which includes one or more processors configured to compute an estimated position, velocity, and other parameters of each orbital body of the plurality of orbital bodies simultaneously, at least partially by a Kalman filter smoothing process using electromagnetic and/or optical emissions of the orbital bodies and/or ground stations. In certain embodiments, the processor(s) computes the parameters at least partially by a weighted least squares batch estimation process using the emissions of the orbital bodies and/or ground stations, and the system may allow a user to select one or both of the weighted least squares batch estimation process and the Kalman filter smoothing process. In certain embodiments, moreover, the processor or processors compute the estimated position, velocity, and other parameters using a de-weighting scheme of the weighted least squares batch estimation process to solve for a single pass of data.

In certain embodiments, the system also includes force models to account for different forces acting on the orbital bodies, such as models for space vehicle thrusting, the Earth oblateness change rate, solid Earth tides, ocean tides, indirect oblateness due to lunar gravity, general relativity accelerations, and the Mass Spectrometer and Incoherent Scatter (MSIS) atmosphere for aerodynamic drag, where the processor or processors compute the estimated position, velocity, and other parameters at least partially according to at least one of the force models. In certain embodiments, the processor(s) is/are configured to compute estimated anomalistic accelerations for the orbital bodies. In certain embodiments, moreover, the processor(s) is/are configured to read an a-priori initial condition file to obtain an initial guess of each orbital body's position, velocity and other parameters. Certain embodiments of the system further include one or more user-specified models for drag, solar radiation, albedo and/or spacecraft attitude, and the processor(s) is/are configured to compute the estimated position, velocity, and other parameters of each orbital body at least partially according to the user-specified model(s). The processor(s) in certain embodiments is/are configured to compute at least one tracking measurement error. The system in certain embodiments further includes a data simulator component implemented using the processor(s), which simulates tracking measurements to model position, navigation and timing determination, and prediction performance.

In accordance with further aspects of the present disclosure, a computer-implemented method is provided for estimating the position, velocity and other parameters of a plurality of orbital bodies. The method includes computing an estimated position, velocity, and other parameters of each orbital body of the plurality of orbital bodies, simultaneously, at least partially by a Kalman filter smoothing process using electromagnetic and/or optical emissions of the orbital bodies and/or ground stations.

The method in certain embodiments includes computing the estimated parameters at least partially by a weighted least squares batch estimation process. In certain embodiments, the estimated parameters for the orbital bodies are computed using a de-weighting scheme of the weighted least squares batch estimation process to solve for a single pass of data. In addition, certain embodiments further include allowing a user to select one or both of the weighted least squares batch estimation process and the Kalman filter smoothing process for computing the estimated parameters. Certain embodiments of the method also include storing force models to account for different forces acting on the orbital bodies, including models for space vehicle thrusting, the Earth oblateness change rate, solid Earth tides, ocean tides, indirect oblateness due to lunar gravity, general relativity accelerations, and the MSIS atmosphere for aerodynamic drag. In these embodiments, the estimated parameters are computed at least partially according to one or more of the force models. The method in certain embodiments may further include computing estimated anomalistic accelerations for the orbital bodies. In certain embodiments, moreover, the method includes reading an a-priori initial condition file to obtain an initial guess of each orbital body's position, velocity and other parameters. Further embodiments may also include storing at least one user-specified model for at least one of drag, solar radiation, albedo and spacecraft attitude, and computing the estimated parameters at least partially according to one or more of the user-specified models. In certain embodiments, the method also includes computing one or more tracking measurement errors, and certain embodiments include simulating tracking measurements to model position, navigation and timing determination, and prediction performance.

A system is provided in accordance with further aspects of the disclosure for estimating and refining the knowledge of spatial and temporal states of the components of a satellite system space and ground segments for the purposes of providing a terrestrial navigation accuracy set of information. The system includes one or more processors configured to compute an estimated position, velocity, and other parameters of each orbital body of the plurality of orbital bodies by a Kalman filter smoothing process and/or a weighted least squares batch estimation process using electromagnetic and/or optical emissions of orbital bodies and ground stations. The system receives carrier phase Iridium pseudorange measurements created by one or more ground receivers that have been reformatted by an operations center, and processes the received measurements to create an updated precision position and timing estimate for a plurality of Iridium satellites. The precision estimate includes an updated estimate for the position and timing of the Iridium satellites as well as a high precision prediction of where the satellites will be, and is suitable for creating orbital and timing parameters for uplinking to the Iridium constellation for re-broadcasting to Iridium augmentation service users.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a system diagram illustrating an exemplary orbit/covariance estimation and analysis (OCEAN) system in accordance with one or more aspects of the present disclosure;

FIG. 2A is a simplified side elevation view illustrating satellite trajectories used to establish an estimated nominal trajectory using the system of FIG. 1;

FIG. 2B is a simplified side elevation view illustrating angular errors associated with a nadir pointing satellite with antennas offset from the center of the mass in a fixed position;

FIG. 2C is a simplified side elevation view illustrating angular errors associated with a nadir pointing satellite with antennas pointed toward a ground station;

FIG. 2D is a simplified side elevation view illustrating antenna tracking for nadir pointing higher altitude satellites;

FIGS. 3 and 4 are flow diagrams illustrating an exemplary weighted least squares process and algorithm implemented in the system of FIG. 1;

FIGS. 5 and 6 are flow diagrams illustrating an exemplary Kalman filter/smoother process and algorithm implemented in the system of FIG. 1; and

FIG. 7 is a flow diagram illustrating an exemplary data simulation process in the system of FIG. 1.

### DETAILED DESCRIPTION OF THE DISCLOSURE

One or more embodiments or implementations are hereinafter described in conjunction with the drawings, where like reference numerals are used to refer to like elements throughout, and where the various features are not necessarily drawn to scale.

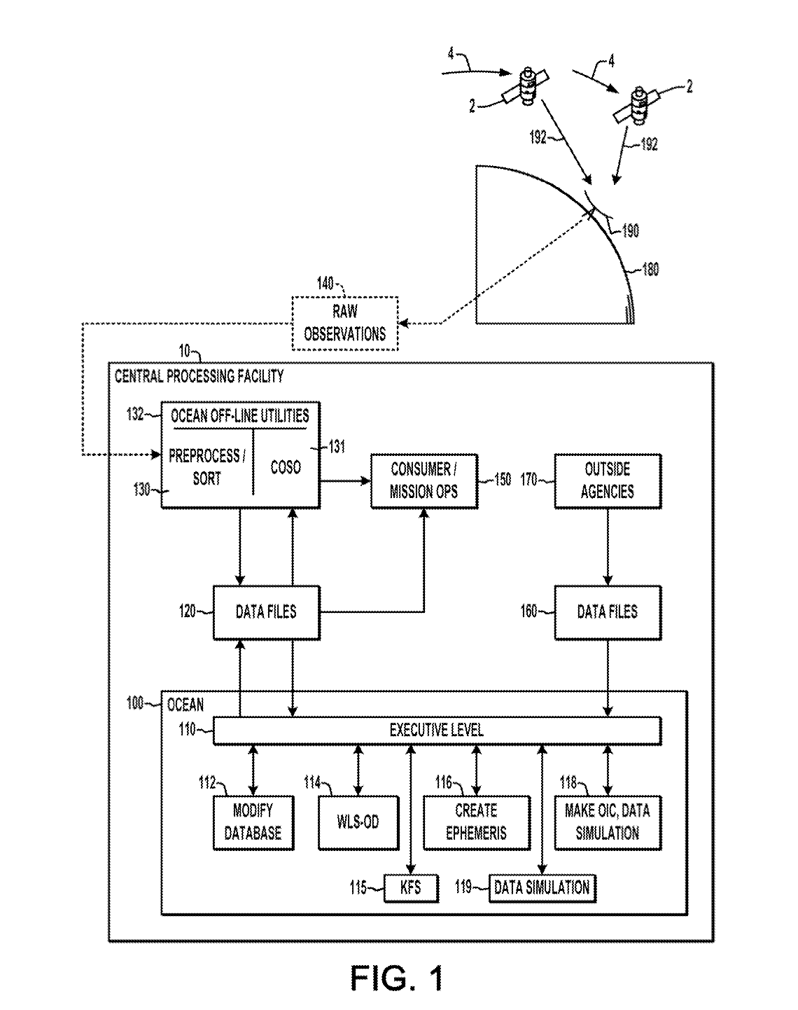

FIG. 1 illustrates an exemplary orbit/covariance estimation and analysis (OCEAN) system 100 in accordance with one or more aspects of the present disclosure. The Orbit/Covariance Estimation and ANalysis (OCEAN) system 100 is implemented as a processor-based system including several main processes or components executing on a server or other central processing facility 10. As shown in FIG. 1, the exemplary OCEAN system 100 includes an executive level 110 along with a Modify Database (MDB) component 112, a Weighted Least Squares Orbit Determination (WLS-OD) component 114, a Kalman Filter-Smoother (KFS) component 115, a Create Ephemeris (CE) component 116, a Make OCEAN Initial Condition (MAKE OIC) component 118 and a Data Simulation (DS) component 119. In operation, the system 100 estimates parameters pertaining to multiple satellites 2 and to ground stations 190. Satellite parameters include positions, velocities, drag and solar radiation coefficients, among others, and ground station parameters include measurement biases and station locations.

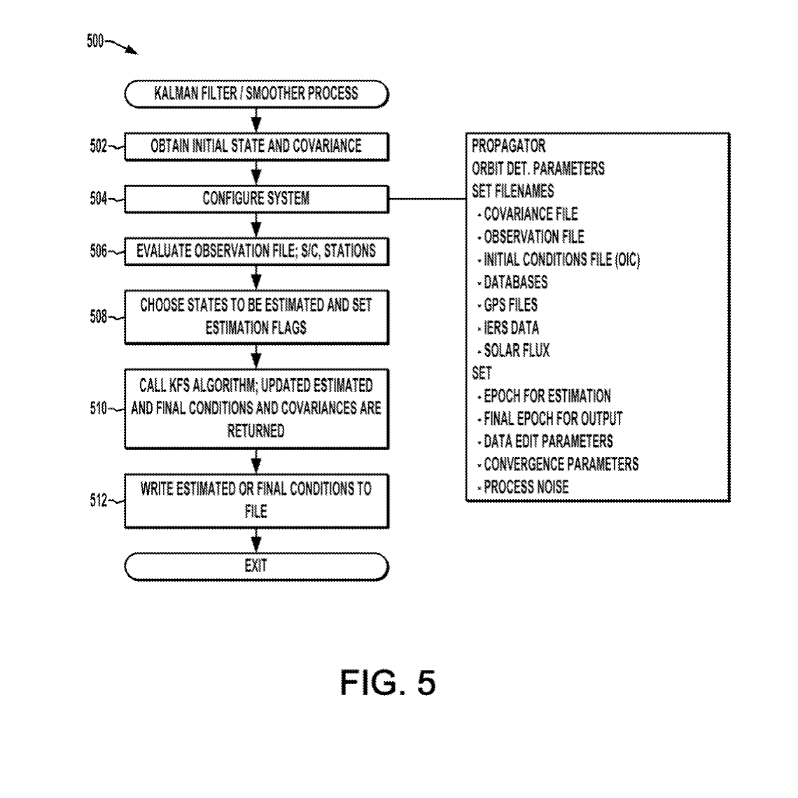

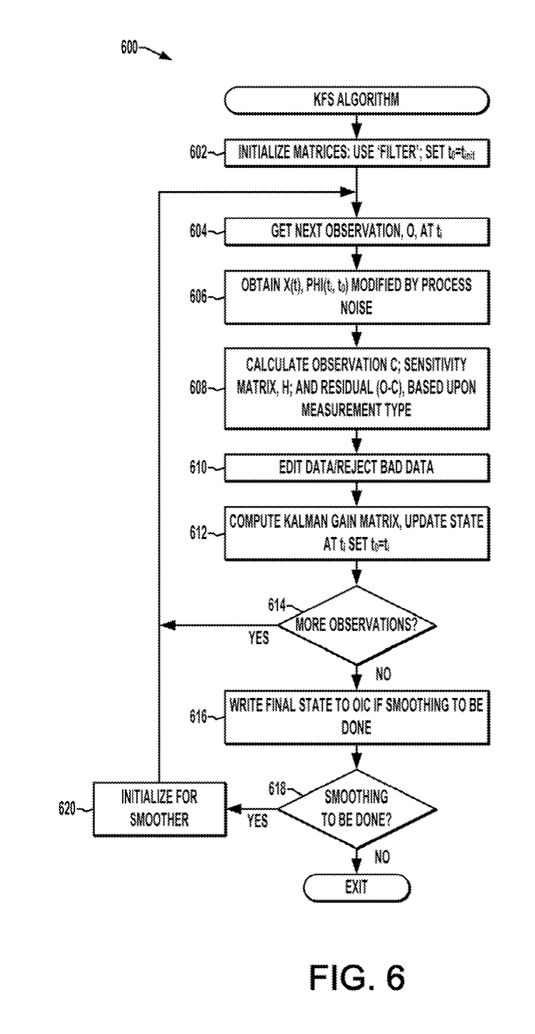

In operation, the system 100 receives and recorded observations (e.g., range, Doppler) and uses these as inputs to a WLS-OD component 114 or to the KFS component 115. The WLS-OD algorithm (e.g., FIGS. 3 and 4 below) is used in an iterative fashion to estimate satellite and ground station parameters, with or without a-priori knowledge of the errors involved. The WLS-OD process 114 is complete in certain embodiments once residuals (e.g., the difference between estimated and observed measurements) satisfy a tolerance defined by the user. The KFS component 115 (e.g., FIGS. 5 and 6 below) estimates a predicted trajectory (i.e., ephemeris) by passing through the data either once or twice. In certain embodiments, the KFS process 115 is complete once all of the data has been processed.

Both the WLS-OD and KFS components 114, 115 in certain embodiments utilize an assortment of observation modeling tools to estimate the desired parameters. Using the results of the estimation process or a predefined initial condition file, the OCEAN system 100 creates an ephemeris for the satellite(s) 2 from a specified initial time to a final time via the CE component 116. The resulting ephemerides can be output in a predefined file format chosen by the user. The ephemerides can be generated directly by WLS-OD and KFS components 114,115. These processes provide the capability to numerically integrate the equations of motion and the variational equations using a sophisticated force model. The MAKE OIC component 118 creates an OCEAN Initial Condition (OIC) file, and the Data Simulation (DS) component 119 allows the user to simulate various measurements. The Modify Database (MD) component 112 can be used by a sophisticated user.

The OCEAN system 100 is described in U.S. Pat. No. 6,085,128, issued Jul. 4, 2000, the entirety of which is hereby incorporated by reference as if fully set forth herein. In addition, the illustrated OCEAN system 100 provides more observation modeling and force modeling capabilities, which allow for greater accuracy in determining satellite and ground station parameters than the version of OCEAN described in U.S. Pat. No. 6,085,128.

FIG. 1 provides an operational overview of OCEAN. In operation, a ground station 190 collects observations 140 of a satellite 2 passing along a trajectory or path 4 overhead. The raw observations 140 are sent to a central processing facility 10 in which the OCEAN system 100 is implemented. The system 100 can be implemented as a standalone system 100 on a server or other processing facility 10, as a program (e.g., application) 100 running on a server 10 accessed via client software running on a user computer (not shown), and/or as a program 100 running on the server 10 accessible via a browser running on a user computer (not shown). The computer 10 can be any form of processor-based computing device, including without limitation servers, desktop computers, laptop computers, notebook computers, netbooks, PDAs, tablets, iPads, smart phones, etc. In addition, the users of the computer 10 can perform various tasks via a user interface of the computer, including keyboards, mouse, and other data entry and/or display tools (not shown) by which data can be entered into the computer 10 and output data, plots, etc. can be rendered to the user. The computer 10, moreover, may be operatively interconnected with one or more networks (not shown). The processing facility 10 is a processor-based system including a processor operatively coupled with an electronic memory (not shown), where any suitable processing component or components and electronic memory can be used, including without limitation microprocessors, microcontrollers, programmable logic, analog circuitry, and/or combinations thereof, and the various components and functionality of the system 100 can be implemented in a single processing device 10 or may be implemented in distributed fashion among a plurality of processing elements. The processes (components) 110-119 of the OCEAN system 100 can be implemented, for example, as computer-executable instructions stored in the memory of the processing facility 10 or other non-transitory computer-readable medium (e.g., CD-ROM, flash memory, disk drive, etc.) with the instructions being executed by the processor(s) of the facility 10.

One of two OCEAN off-line utility programs or components, PREPROCESS/SORT 130 or Create OCEAN Standard Observations (COSO) 131, processes the raw data 140 into preprocessed data files 120 usable by the system 100. In the example of FIG. 1, the PREPROCESS/SORT and COSO utility programs 130 and 131, respectively, can be implemented in the OCEAN system 100 or in the same central processing facility 10. Outside agencies 170 also provide data files 160 that can be used by the OCEAN system 100, such as the solar flux and International Earth rotation and Reference systems Service (IERS) data files 160. The OCEAN system 100 can be executed either automatically (in operational mode) or manually (in interactive mode) by a user using the preprocessed data file 120 (and/or the externally supplied data file(s) 160) is used and an orbital solution for the satellites 2 involved in the problem is generated (data file(s) 120) and passed to either the consumer 150 or the OCEAN off-line utilities 132 for further analysis.

The system 100 in certain embodiments estimates the positions, velocities, and other parameters of multiple satellites 2 and celestial bodies by processing simultaneous orbit determination solutions for a multiple satellites 2 within the computer 10 and facilitates display of the results on an x-y plotter, visual display, or printer (not shown). It may also be used to estimate parameters for other elements, such as the locations of ground stations 190 and measurement biases associated with the ground stations 190. The system 100 uses recorded observations 140 (e.g., range, Doppler) and measurements from various sources as inputs to a weighted least squares batch estimation algorithm 114 (e.g., FIGS. 3 and 4 below) which is performed in an iterative fashion to estimate each parameter, with or without a priori knowledge of the errors involved with each observed parameter. The WLS component 114 completes processing once the residual satisfies a tolerance defined by the user. Using the results of the estimation process or a predefined initial condition file, the CE component 116 generates a predicted trajectory 4 (ephemeris) for the satellite(s) 2 from a specified initial time t₀ to a final time t_{f}. The resulting ephemerides 4 are output in a predetermined file format 120, 160 that can be specified by a user. The system 100 in certain embodiments can be completely configured using a database (not shown) which determines the specific parameters to be used for each new orbit determination problem.

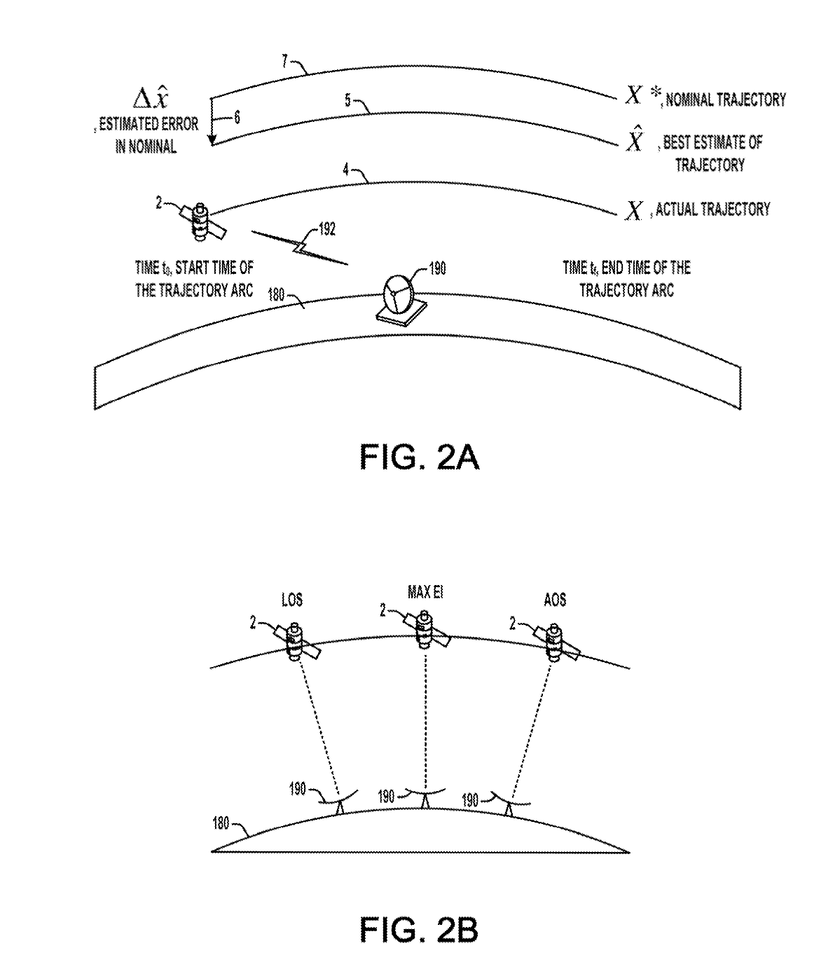

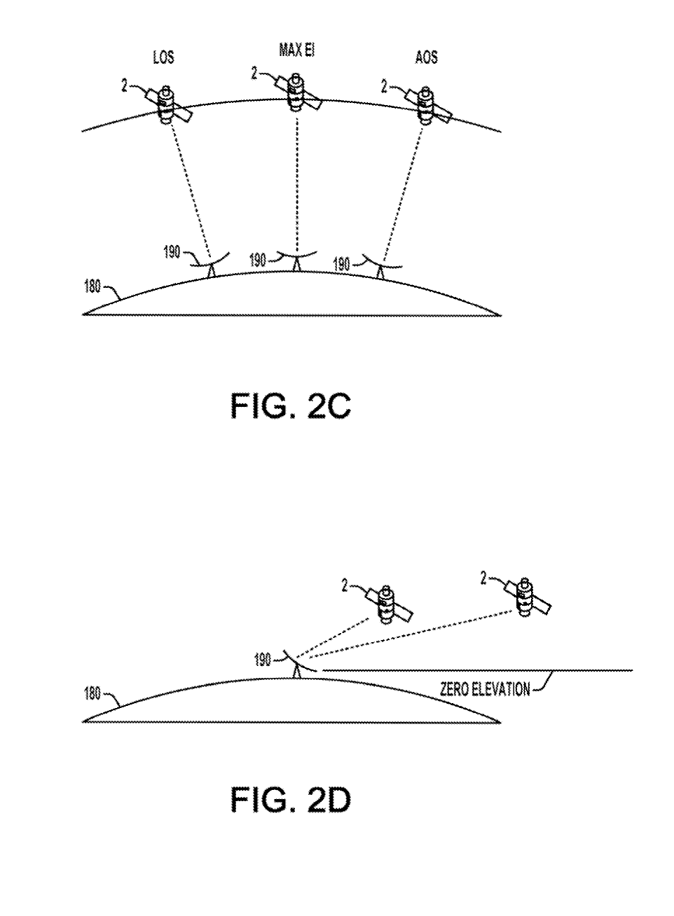

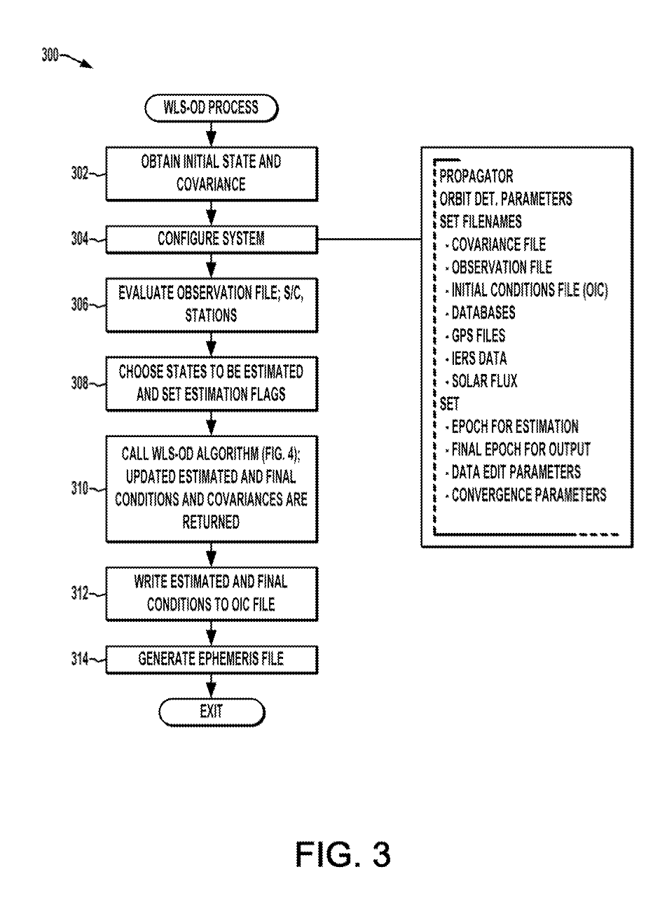

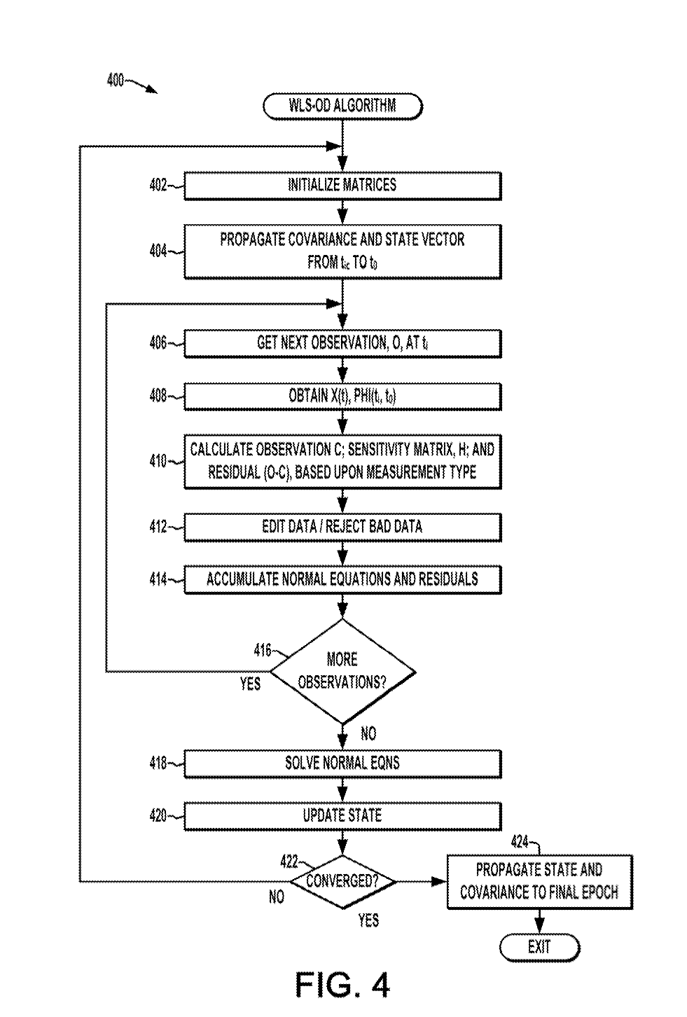

Referring also to FIGS. 2A-2D, the goal of the WLS-OD component 114 and/or of the KFS component 115 is to estimate a given state vector at some specified time, which is usually at the beginning or end of a data arc. It is common to include the orbital body's position and velocity as a part of the state; however, it is also possible to estimate such parameters as ground station locations 190, measurement model biases, satellite coefficient of drag, etc. In the example of FIGS. 1 and 2A, the satellites 2 follow an actual trajectory X (4) representing absolute truth, which would be known if the physical world were perfectly modeled. However, only the best possible estimate of trajectory 5 \hat{X} (FIG. 2A) can be determined through orbit determination. This “best” trajectory \hat{X} (5) depends upon the exactness of the dynamical model and on the quality of the measurements; (e.g., range, Doppler, etc.). The “best” trajectory 5 \hat{X} is solved for using the orbit determination process. A reference or nominal trajectory 7 X*, must be used as the starting point as the basis of the solution. The batch least squares component 114 estimates the difference between the nominal and the best estimate trajectories X* 7 and \hat{X} 5, respectively. This is also called the estimated error in the nominal trajectory, Δ\hat{x} (6), and the best estimate at the initial time t₀ is expressed as \hat{X}₀=X*₀+Δ\hat{x}.

The estimation process uses the information contained in the measurements 140, such as range or Doppler shift of a satellite's actual trajectory 4 taken by a ground station 190 to provide an updated trajectory. Each measurement has a sensitivity to the errors in the actual trajectory 4 with respect to an a priori satellite 2 state (e.g., position, velocity) at an initial epoch or time value t₀. These sensitivities provide a measure of the statistical error or covariance associated with the best trajectory 5. The sensitivity, or estimate error in nominal trajectory 6, at the time of each measurement is mapped to this initial estimation epoch. The accumulation at t₀ of all sensitivities from all measurements 140 along with the accumulation of the residuals 6 between the theoretical and actual measurements allows the error in the state to be estimated at t₀. The equations used in the accumulation and estimation are called the normal equations. If the user specifies a final epoch (t_{f}) at which to report the state, then the solved for state must be propagated to this epoch t_{f}. The current state vector includes satellite parameters, ground station 190 locations, ground station parameters, and miscellaneous parameters. The system 100 in certain embodiments can be configured at compile time for the maximum allowable number of satellites 2 and ground stations 190. In certain implementations, moreover, for each satellite 2, eleven parameters can be estimated, including three states corresponding to the satellite's 2 position; three states corresponding to the satellites 2 velocity; a coefficient of drag; a decay state; a reflectivity coefficient; and two states for frequency offset and drift of the satellite's clock, if required.

Referring also to FIGS. 2B-2D, each ground station 190 may have multiple antennas, and for each ground station 190, the position of each antenna and the frequency bias for all antennas at a site can be estimated. In this regard, it may be assumed that any other antennas at the given site are known well in relation to each other, so estimating one ground station 190 implies improvement in knowledge of all antennas. Treating individual antennas as one ground station 190 with a plurality of ground stations 190 is easily accomplished, if desired. In certain embodiments, the underlying orbital calculations performed in the system 100 are made in the Mean Equator and equinox of J2000.0 coordinate frame. The internal time scale for all computation is International Atomic Time (TAI). It is convenient to carry out the trajectory integration in this coordinate frame and time scale; however, depending on the application, the state of the satellite 2 may be referenced to other coordinate frames and time scales. For example, most satellite 2 tracking measurements are referenced to an Earth 180 fixed coordinate frame and to Coordinated Universal Time (UTC). Moreover, biases for each measurement type selected can be estimated, where a single bias can be estimated for the entire data span, or pass-by-pass biases can be estimated. Biases may be estimated for satellite 2, ground station 190 or by link (satellite-station pair).

FIGS. 2B and 2C illustrate angular error associated with a nadir or fixed pointing satellite 2 with a receive antenna offset from the center of the mass. In FIG. 2B the antenna is fixed while in FIG. 2C the antenna points toward the ground station 190. The ground station 190 is depicted in these figures in the three different phases as it tracks the satellite 2. The phases are Acquisition of Signal (AOS), the maximum elevation (MaxEl), and the Loss of Signal (LOS). Note the range from the station 190 to the phase center of the satellite 2 antenna is different from the range from the station 190 to the satellite 2 center of mass. It is the position and velocity of the center of mass that is estimated by the component 114 of the system 100 in the WLS-OD problem (and of the KFS component 115). The secondary effect of antenna offsets is active vs. passive tracking by the satellite 2 antenna. If the antenna can be pointed toward the target, in this case the ground station 190, then the antenna offset effect is reduced. This effect is usually small and is not applied in all embodiments of the system 100. In certain implementations, moreover, all antennas are considered passive and fixed in orientation with respect to the satellite(s) 2.

In this regard, the curvature of the Earth 180 is not taken into account in certain embodiments shown in FIGS. 2B and 2C. For a nadir pointing satellite 2, the curvature of the earth 180 reduces the angular error due to geometry. The higher the altitude of the satellite 2 the lower the error at low elevations. FIG. 2D demonstrates this effect, wherein the angular difference between the line of sight vector from the station 190 to the satellite 2 and the nadir pointing antenna is lower (i.e., the line of sight vector and the antenna are more collinear) for the Highly Eccentric Orbit (HEO) satellite than the Low-Earth Orbiting (LEO). The macro models in certain embodiments of the OCEAN system 100 automatically incorporate the curvature effect. Two antenna models are used in OCEAN. One is a generic model based on a nadir-pointing satellite 2 rotated by a roll-pitch-yaw series of attitude angles and the second model is based on the TOPEX satellite.

The state transition matrix (STM) relates the state at one time to the state at another time. The STM can be computed in this program one of two ways: (1) using an analytical two-body approximation for the satellite 2 dynamical equations of motion; and (2) integrating the variational equations. When estimating ground station 190 parameters such as the station 190 location, transformations of the STM from CTS to inertial coordinates are modeled, as discussed below. Integration of the variational equations provides a method for reducing the amount of approximation and linearization and allows the estimation of such parameters as coefficient of drag and reflectivity coefficient. This may improve the rate of convergence.

Referring again to FIG. 1, as the ground station 190 collects observations of a satellite 2 passing overhead, the raw observations or data 140 are sent to a central processing facility 10 implementing the system 100. An off-line utility program or component 130 called Preprocess processes the raw data 140 into files 120 usable by the OCEAN system 100. Outside agencies 170 also provide files 160 to be used by the OCEAN system 100. The OCEAN system 100 is executed either automatically or manually by a user or consumer/mission operations 150. The preprocessed data file 120 is used and an orbital solution for the satellites 2 involved in the problem is generated and passed either to the consumer 150 or to the OCEAN 100 off-line utilities 132 for further analysis. The main processes within the OCEAN 100 program are an executive level 110 with WLS-OD/KFS routines 114, 115, a CE routine 116, a Make OCEAN Initial Condition (OIC) routine 118, and a Modify Database (MDB) routine 112. In both the automatic and manual modes, the OCEAN system 100 execution is driven largely by the values in its database that allow each sub process or component of the OCEAN system 100 to be configured independently of all other subprocesses or components. Additionally, an override file is provided to independently override any database setting for each subprocess or component. In the automatic mode, statistical data editing is controlled by the program according to database command settings. None of these activities requires operator intervention. In the manual mode, the user executes the OCEAN system 100 interactively to examine and analyze different processing strategies. In the manual mode, the user sets the statistical data editing settings interactively. If the OCEAN system 100 is run interactively, then the OCEAN system 100 will output messages or information to the screen (not shown). Some messages require user responses and the OCEAN system 100 will act on them accordingly. This process continues until the OCEAN system 100 ends a specific process and prompts the user for the next action. In certain embodiments, moreover, before OCEAN 100 actuates all components WLS-OD 114, CE 116, OIC 118, and MDB 112, the system parameters required by each function are initialized. This includes selecting the satellites 2 and ground stations 190 involved in the problem, choosing the states to be estimated, and configuring all remaining parameters that are used for successful completion of the selected process. In certain embodiments, the system 100 uses two files to configure the system 100 for all processes: the installation file and Database file. In addition, other files may be used by a given process or component, for instance, where certain embodiments of the WLS-OD component 114 process employs an estimation file and a covariance file.

The OCEAN system in certain embodiments can run on DEC VAX and ALPHA processing facility systems 10 running Open VMS, in a UNIX environment, or in a LINUX environment. In the operational mode the user has initially defined appropriate OpenVMS DCL or UNIX commands or scripts to perform typical daily operations, and a configured system can perform one some or all of the following on a daily basis: Collect auxiliary data such as thrust firings (or “burns”), solar flux, IERS data (polar motion and UT1/UTC), etc.; Collect raw observation data; Preprocess the data to form a standard observation file; and/or Run the OCEAN system 100 at a specific time (e.g., daily starting at midnight). Once the OCEAN system 100 is invoked in an operational mode, statistical data editing is automatically controlled by the OCEAN system 100 according to database command settings. All of these activities require no direct operator intervention other than monitoring results on a timely basis, and thus the runs of this type are generally executed as a background process. The user can activate the OCEAN system 100 via predefined VMS DCL or UNIX commands in batch mode. If the OCEAN components are submitted as a background batch job, the OCEAN system 100 will execute until termination. In this case, the user can proceed with other functions once the job is submitted.

In the interactive mode, the user interactively operates the OCEAN system 100 to examine and analyze different process configurations. The interactive mode exists primarily for the WLS-OD component 114 and/or the KFS process/component 115. For other processes, this mode is used only for user-supplied input. The user can ensure that the key external files are available (e.g., an observations file for the WLS-OD process 114). When OCEAN is run interactively, messages and other information are sent to the screen. Some messages require user responses and OCEAN will act on them accordingly. For example, the user can set the statistical data editing settings interactively. The WLS-OD process 114 continues until OCEAN terminates and prompts the user for the next action.

The Weighted Least Squares Batch process or component 114 estimates parameters pertaining to one or more satellites 2 and ground stations 190 using a weighted least squares batch algorithm, and may be used with or without a priori error covariance knowledge. In the illustrated example, the WLS-OD component 114 is employed in the following sequence (shown in FIG. 2A). The spacecraft 2 follows the actual or “truth” trajectory 4, using an initial position and velocity state that may be provided by the user and the WLS-OD component 114 creates a nominal trajectory over an arc of 1 to 3 days in one example. Using measurements, the WLS-OD component 114 computes an estimate of the error 6 between the nominal and actual trajectories 7 and 5, respectively. The estimated error 6 is then added to the nominal 7 to provide a new best estimate 5 of the nominal trajectory. These third and fourth steps are then repeated until the estimated error 6 is within a user-defined tolerance. In certain embodiments, moreover, in order to avoid unnecessary processing, the system 100 may discontinue iteration of these steps when a threshold number of iterations has been performed, and simply report the current estimated error 6 to the user, for example, and the system 100 may offer the user the ability to direct the system 100 to perform further iterations. This process is repeated over the subsequent trajectory arcs.

In operation of the illustrated embodiment, the system 100 estimates various parameters at the initial time or epoch t₀ for all the satellites 2 included in the problem. For instance, the system 100 may estimate the mean equator and equinox of an epoch J2000.0 state vector, including position (e.g., in km) and velocity (e.g., in km/sec), as well as a drag coefficient estimated as C_{d} (dimensionless) or as \dot{α} (the rate of change of the semi-major axis in km/sec). The system 100 in certain embodiments also estimates a solar radiation coefficient as Cᵣ (dimensionless), the magnitude of planned thruster firings or burns, anomalistic acceleration coefficients, measurement range and range-rate biases, a GPS or carrier phase clock model, station locations and/or covariance for the above items. In some implementations, the system 100 provides an estimate data set, such as an N×N array, where N is the integer number of estimated parameters.

The spacecraft, satellite or other orbital body 2 follows an actual trajectory 4. Since only an estimated trajectory 5 can be determined through orbit determination, the “best” trajectory 5 depends upon the exactness of the dynamical model and on the quality of the measurements 140. In certain embodiments, the system 100 processes one or more of the measurement types shown in Table 1 below where AFSCN is the Air Force Satellite Control Network, SSN is the Space Surveillance Network, GPS is the Global Positioning System, and Fence is the space surveillance radar system:

TABLE 1
Measurement types

Measurement Type
Absolute and relative 3-way range
Satellite Laser Ranging (SLR)
Absolute and relative 1-way range
AFSCN and SSN range
AFSCN and SSN azimuth and elevation
AFSCN and SSN range-rate
Inter-Satellite Range Data (ISRD)
Ephemeris position (X, Y, Z)
Fence - E/W Direction cosines and N/S
Direction Cosines
GPS
Carrier Phase

The system 100 solves the “best” trajectory 5 in certain embodiments using the orbit determination process implemented by the component 114. A reference or nominal trajectory X* is used as the starting point in generating a solution. The WLS-OD component 114 uses a batch least squares algorithm to estimate the difference Δ\hat{x} (6) between the nominal and best estimate trajectories, referred to as an estimated error in the nominal. The value of Δ\hat{x} (6) is determined over the start (t₁) and end (t_{f}) times of the trajectory arc. At the initial time t₀, the best estimate 5 is defined as follows, wherein a subscript “0” refers to the time t₀):

\hat{X}₀=X*₀+Δ\hat{x} (1)

X*₀ is obtained by the component 114 of the system 100 by integrating the equations of motion using the Initial Conditions (IC) X*_{IC} at time t_{IC}:

X*₀=I(\ddot{X}(X*_{IC},t_{IC}),t₀) (2),

where I is the integration of the equations of motion between two times. In the classical weighted least squares process a theoretical model is developed for each measurement type. When an actual measurement is taken, there is a difference or error between the actual and modeled measurements. Since the model uses the state in its computation, the observations and states are related by:

Yᵢ=Gᵢ(X*ᵢ,tᵢ)+εᵢ (3),

where Yᵢ is the vector of observation at time tᵢ, X*ᵢ is the propagated state vector based on X̅*₀ at time tᵢ, Gᵢ is the computed theoretical observation as a function of the state at time tᵢ (see Table 1 for measurement types), εᵢ is the observation error at tᵢ and i is 1, 2, 3, . . . , I, where I is the number of observations.

It is noted that there may be more than one observation at time tᵢ. Implicit in the calculation of Equation 3 are several optional corrections. Antenna offsets, Xₐₙₜ, correct for the location of antennas with respect to the vehicle center of mass:

X*ᵢ=X*ᵢ+Xₐₙₜ (3a)

The system 100 also has the capability to compute a range atmospheric delay due to the troposphere, denoted as Δt. Four troposphere models—Hopfield, Marini-Murray, Choi and Goad-Goodman—are provided in certain embodiments of the OCEAN system 100. In addition, an ionosphere correction Δi is computed in certain embodiments via a Klobuchar model. For range and range-rate measurements, certain embodiments of the system 100 can apply (or apply and solve for) a bias Δb, in which case equation 3 can be augmented as follows:

Yᵢ=Yᵢ+Δt+Δi+Δb (3b)

The estimation process finds a value of X* (7) that minimizes the weighted sum of the squares of the measurement residuals 6, according to the following equation:

Δyᵢ=(Yᵢ−Gᵢ(X*ᵢ)) (4)

In this regard, the following scalar, J, is minimized:

J(X*)=(Yᵢ−Gᵢ(X*ᵢ))^{T}W(Yᵢ−Gᵢ(X*ᵢ)) (5),

where W is the weight matrix, and the transpose of a matrix is denoted by a superscript T.

Yᵢ and Δyᵢ are subject to editing criteria as shown below. The weight W for each observation type is based on σ, the user-specified observation noise. It is assumed that the observation error, ε, is random with zero mean and specified covariance. The weight W is equal to the inverse of the expected value of the observation error squared.

$$W = [ \begin{matrix}\frac{1}{{σ}_{1}^{2}} & 0 & … & … & 0 \\ 0 & ⋱ & & & ⋮ \\ ⋮ & & ⋱ & & ⋮ \\ ⋮ & & & ⋱ & 0 \\ 0 & … & … & 0 & \frac{1}{{σ}_{1}^{2}}\end{matrix} ] \qquad ( 6 )$$

Observations are edited in four ways via the system 100. First, an observation is only used in the current iteration if the absolute value of the residual, Δyᵢ, is below maxⱼ, a user specified limit for observation type j:

|Δyᵢ|≦maxⱼ (7a)

Second, for station data an elevation test is done. An observation is only used if the elevation of the satellite with respect to the ground station Eᵢ exceeds a user specified limit Eₘᵢₙ.

Eᵢ≧Eₘᵢₙ (7b)

Third, three additional test are performed for GPS data, including a spacecraft elevation test, a spacecraft grazing altitude test, and a GPS PRN signal “health” test. For the spacecraft elevation test, an observation is only used if the elevation between the spacecraft and the GPS, SC_Eᵢ, exceeds a user specified limit SCEₘᵢₙ:

SC_{—}Eᵢ≧SCEₘᵢₙ (7c)

For the spacecraft grazing altitude test, an observation is only used if the grazing altitude, SC_Gᵢ, exceeds a user specified limit, SC_graz:

SC_{—}Gᵢ≧SC_graz (7d)

For the GPS PRN signal “health” test, an observation is not used if the PRN is found not to be healthy.

The system 100 also performs a statistical editing test. The user defines editing criteria, constants k and resmin, such that the measurement is rejected if either of the following occur:

|Δyᵢ≧k [symbol] prmsⱼ (8a)

or

|Δyᵢ|≧resminⱼ (8b).

The value prmsⱼ is the root mean squared observation error (rms) of the previous iteration (see Equation 23 below). It is noted that in certain embodiments, the system 100 only computes the rms on the first or 0^{th} iteration, and the preceding equation 8b is used whenever the following occurs:

|resminⱼ|≧k [symbol] prmsⱼ (8c).

In classical WLS-OD embodiments, moreover, Equation 5 is augmented to include the constraint placed on the a-priori value of X*₀ by the a-priori uncertainty (i.e., the covariance matrix) P_{ΔX*}_{₀}⁻¹:

J(X*)=(Yᵢ−Gᵢ(X*ᵢ))^{T}W(Yᵢ−Gᵢ(X*ᵢ))+(X*−X*₀)^{T}P_{ΔX*}_{₀}⁻¹(X*−X*₀) (9)

The variational equations are used in certain embodiments to obtain a state transition matrix Φ(t₀, t_{IC}) which is then used to obtain P_{ΔX*}_{_{0:}}

P_{ΔX*}_{₀}=Φ(t₀,t_{IC})P_{ΔX}_{_{IC}}Φ(t₀,t_{IC})^{T} (10),

where P_{ΔX}_{_{IC}} is the covariance matrix at time t_{IC}. The value of X* that minimizes J is a solution of the following equation:

$$\frac{\partial J}{\partial {X}^{*}} = - 2 [ \begin{matrix}{( {Y}_{i} - {G}_{i} ( {X}_{i}^{*} ) )}^{T} W \frac{\partial G ( {X}_{i}^{*} )}{\partial {X}_{i}^{*}} + \\ {( {X}^{*} - {X}_{0}^{*} )}^{T} {P}_{Δ {X}_{0}^{*}}^{- 1}\end{matrix} ] = 0 \qquad ( 11 )$$

Equation 11 is linearized by the system 100 before it can be solved. Expanding G(X*) in a Taylor series about X*₀ yields:

G(X*)=G(X*₀)+HΔ X̅ (12),

where:

$$\begin{matrix}Δ \overline{X} = ( {X}^{*} - {X}_{0}^{*} ) , & ( 13 ) \\ H = {\sum }_{i = 1}^{l} {\tilde{H}}_{i} Φ ( {t}_{l} , {t}_{0} ) , and & ( 14 ) \\ {\tilde{H}}_{i} = \frac{\partial {G}_{i} ( {X}_{i}^{*} )}{\partial X ( {t}_{i} )} . & ( 15 )\end{matrix}$$

The \tilde{H} matrix is evaluated by the system 100 at the measurement time tᵢ, and is mapped back to the initial time t₀ by multiplying \tilde{H}ᵢ by Φ(tᵢ, t₀), the state transition matrix obtained from integrating the variational equations evaluated from tᵢ to t₀. Using Equations 4 and 12, the term Yᵢ−G( X̅ᵢ) in Equation 11 becomes:

Yᵢ−Gᵢ(X*ᵢ)=Yᵢ−Gᵢ(X*₀)−HΔ X̅=Δ y̅−HΔ X̅ (16).

Next, an iterative scheme is used, with Equation 13 rewritten as:

Δ X̅=(X*−\hat{X}₀) (17),

where \hat{X} is the best estimate 5 at iteration n (equal to X*₀ when n=0).

Defining:

Δ\tilde{x}=(X*₀−\hat{X}ⁿ) (18),

and substituting Equations 16, 17 and 18 into Equation 11 yields:

$$\frac{\partial J ( Δ \overline{X} )}{\partial Δ \overline{X}} = - 2 ( Δ \overline{y} - H Δ \overline{X} ) WH + ( Δ \overline{X} - Δ \tilde{x} ) {P}_{Δ {X}_{0}^{*}}^{- 1} = 0. \qquad ( 19 )$$

The value of Δ X̅ that minimizes Equation 19, defined as Δ\hat{x}, is:

Δ\hat{x}=(H^{T}WH+P_{ΔX*}_{₀}⁻¹)⁻¹(H^{T}WΔy+P_{ΔX*}_{₀}⁻¹Δ\tilde{x}) (20).

In the formulation of Equation 20, let:

M=H^{T}WH+P_{ΔX*}_{₀}⁻¹ (21a)

And

L=H^{T}WHΔy (21b)

Equations 21a and 21b are termed the normal equations. The estimate of the error Δ\hat{x} is then used to update the nominal trajectory X* to provide the best estimate 5 of the state \hat{X}. Repeating Equation 1 yields:

\hat{X}=X*+Δ\hat{x} (22).

Finally, a test for convergence is performed by the system 100. In this comparison, the root-mean-square rmsⱼ is computed for each observation type j:

$${rms}_{j} = \sqrt{\frac{{\sum }_{i = 1} Δ {y}_{i}^{2}}{lj}} , \\ i = 1 , … , lj \qquad ( 23 )$$

where Ij refers to the number of observations of different types j, and j=1, 2, 3 . . . represents measurements. If the difference between rmsⱼ values of two successive batch iterations is less than a user specified tolerance εⱼ for all observation types, then the system has converged. Thus, convergence is reached if:

|rmsⱼ−prmsⱼ|<εⱼ (24),

where prmsⱼ is the value of rmsⱼ at iteration n−1. If the algorithm does not converge, then the best estimate 5 of the trajectory becomes the nominal 7:

X*=\hat{X} (25)

This system 100 iteratively performs this process in certain embodiments until convergence (i.e., Equation 24 is satisfied for all measurement types). In certain embodiments, the system 100 deems the process as diverging if the number of iterations, n, exceeds a user specified limit.

On convergence, the final value of X* becomes the new initial condition, X*_{IC}, used in Equation 2. The inverse of matrix M will be the new covariance matrix, P_{ΔX}_{₀}, used in Equation 10.

P_{ΔX}_{₀}=M⁻¹=|H^{T}WH+P_{ΔX*}_{₀}⁻¹|⁻¹ (26)

Referring also to FIGS. 3 and 4, flow diagrams 300 and 400 illustrate an exemplary weighted least squares process and algorithm implemented in certain embodiments of the system 100. In the WLS-OD procedure 300 of FIG. 3, the required files (as shown in Table 2 below) are defined, and the system 100 reads the database command, initial state and covariance at 302 and the system is configured at 304. At 306, the system 100 loads and analyzes the observation file, and configures the propagator, constants, force model and WLS-OD parameters. The system 100 also analyzes the estimation and covariance files at 306, configures the system and prints the initial conditions. At 308, the user (or the system 100) choses states to be estimated and sets estimation flags.

At 310, the system 100 calls or otherwise executes the WLS-OD estimation process/component 114 (further detailed in FIG. 4 below). Once the WLS-OD component 114 finishes the weighted least squares processing, the system optionally writes the fitted and predicted (estimated and final) states to the OIC file at 312. At 314, the system 100 optionally generates an ephemeris file and a covariance history file, and a “Satellite Tool Kit ephemeris file” is optionally processed to complete the processing.

TABLE 2
Files used by the OCEAN system:

| Type of File | Description |
|---|---|
| Database File | Includes commands used to configure the system |
| Override File | Includes commands used to override the database |
| Supplemental | Lists directory containing supplemental database |
| Directory | files |
| Leap second File | Lists dates when a leap second was added |
| Mark 3 File | Includes polar motion and Delta UT1 data |
| Burn File | Lists all burns that have been applied to a |
| | spacecraft |
| Solar Panel File | Includes solar panel attitude information |
| Attitude Directory | Lists directory containing attitude files |
| Solar Activity File | Solar Flux and Geomagnetic Index History File |
| OLES File | Includes a one-line element set for each spacecraft |
| Output File | Includes a history of results from an OCEAN run |
| GPS Broadcast File | A directory which contains the broadcast navigation |
| | data in RINEX format |
| GPS SP3 File | A directory which contains precise GPS ephemeris |
| | information in the SP3 format |
| GPS PRN File | Includes the operational history of GPS regarding |
| | PRNs and SVNs |
| Troposphere File | Includes weather data used with CHOI troposphere |
| Tides File | Includes Ocean tides coefficients |
| Acceleration File | Includes accelerations |
| Geomagnetic Poles | Includes latitude and longitude of North and South |
| | geomagnetic poles |
| Iono Composite | Includes coefficients for the Klobuchar ionosphere |
| | model |

FIG. 4 illustrates a process 400 for implementing the WLS-OD algorithm in the system 100 (WLS-OD component 114 in FIG. 1, call step 310 in FIG. 3). The processing 400 implements a differential correction algorithm that returns the updated estimated and final conditions and covariances as described herein. A number of matrices are initialized at 402 including a nominal estimate of the state, X*_{IC} at the initial time, t_{IC}; an initial covariance matrix, P_{IC}; an estimate initial epoch, t₀; a final epoch, t_{f}; and an estimate of observation noise, ζ to begin the differential correction process 400. At 402, the system 100 initializes weights and covariance matrices, and nulls M and L matrices. At 404, the system 100 propagates covariance matrix and state from the initial conditions at t_{IC} to t₀ and sets the time tᵢ₋₁ equal to 0. An internal loop begins at 406-414, with the system 100 preparing an observation file and reading a first (next) observation “O” at 406 at time tᵢ. At 408, the system 100 calculates an observation, calculates a sensitivity matrix H, and calculates a residual based upon the measurement type, by integrating the nominal trajectory and state transition matrix from tᵢ₋₁ to tᵢ, calculating the sensitivity matrix, Hₜ, at tᵢ, mapping Hᵢ to time t₀ (labeled H), calculating the theoretical observation, C, and calculating the residual y. Data editing is performed and the system checks constraint and residual limits at 412. If the elevation is low or the residual is bad, the bad data is rejected at 412. At 414, the system 100 accumulates normal equations and residuals, evaluates the M and L matrices, and determines at 416 whether more observations are available. If so (YES at 416), the system 100 sets tᵢ₋₁ equal to tᵢ and the process 400 returns to 406 as discussed above. Otherwise (final observation, NO at 416), the system 100 solves the normal equations at 418 and estimates error in the state Δ\hat{x}. The nominal state X*₀ is updated by adding Δ\hat{x} and the system 100 computes the rms at 420. At 422, the system 100 determines whether the computed rms is sufficiently converged. If not (NO at 422), the process 400 returns to 402 as described above. If sufficient convergence has been achieved (YES at 422) the system 100 propagates state and covariance to the final epoch (t_{f}) at 424 to complete the WLS-OD algorithm (completes the call at 310 in FIG. 3 above).

Referring now to FIGS. 5 and 6 flow diagrams 500 and 600 illustrate an exemplary Kalman filter/smoother (KFS) process and algorithm implemented in the KFS component 115 of the system 100 in FIG. 1. The system 100 advantageously allows alternative or combined usage of one or both of the WLS-OD component 114 and/or the KFS component 115 (FIG. 1). In certain embodiments, the system 100 allows a user to select which of these components will be employed for orbit determination processing by the system 100. In other embodiments, the system 100 selects one or both of these components 114, 115 for use in a given problem solution situation.

The KFS processing 500, 600 in the component 115 estimates the satellite position, velocity and related parameters that best fit the tracking measurements. Unlike the WLS-OD technique, however, the state is continuously updated by the component 115 after each measurement is processed using the KFS approach. In certain embodiments, the KFS component 115 is primarily used with GPS measurements and some of the range-type measurements. The exemplary KFS component 115 estimates various parameters, including without limitation a mean equator and equinox of epoch J2000.0 state vector (e.g., including position (in km) and velocity (in km/sec)), a drag coefficient as C_{d} (dimensionless), or \dot{α}, the rate of change of the semi-major axis (in km/sec), a solar radiation coefficient as Cᵣ (dimensionless), a GPS clock model, and measurement range biases.

At 502 in FIG. 5, the system 100 obtains an initial state and covariance, and the system 100 is configured at 504 with the necessary propagator, orbit determination parameters, and files as seen in FIG. 5, and various parameters are initialized or set including epoch for estimation, final epoch for output, data edit parameters, convergence parameters, and process noise parameters. At 506, the system 100 evaluates the observation file, S/C and the ground stations 190. At 508, the system 100 chooses states to be estimated and sets estimation flags. At 510, the system 100 calls the KFS algorithm (as further detailed below in connection with FIG. 6), and receives from the KFS component 115 updated estimated and final conditions and covariances. At 512, the system 100 writes estimated or final conditions to a file to complete the KFS processing 500.

Referring also to FIG. 6, the exemplary KFS algorithm process 600 involves initializing matrices, using “filter”, and setting t₀ equal to tᵢₙᵢₜ at 602. At 604, the next observation “O” is obtained at tᵢ. The state X, along with the state transition matrix Φ(tₖ, tₖ₋₁) is integrated at 606 to tₖ (the first (or next) measurement time) to obtain the following:

X*ₖ=I(\ddot{X}(X*ₖ₋₁,tₖ₋₁)tₖ) (27),

where (X*₀,t₀) represents the initial conditions for k−1=0. The state transition matrix Φ(tₖ, tₖ₋₁) is obtained at 606 by integrating the variational equations evaluated from tₖ to tₖ₋₁. The covariance matrix Pₖ is propagated at 606 using Equation 28, below:

Pₜ=Φ(tₖ,tₖ₋₁)Pₖ₋₁Φ^{T}(tₖ,tₖ₋₁)+Q(Δt) (28),

where P₀ is specified at filter initialization at 602. The variable Q(Δt) is a measure of the error between the reference state and the true state which arises from an imperfect model.

At 608, the system 100 calculates the observation C, the sensitivity matrix H, and the residual (O-C) based upon the measurement type. Computation of the measurement, C(Xₖ, tₖ), is similar to computation in the WLS-OD process described above in connection with FIG. 4. The measurement residual is given by Equation 29:

yₖ=Yₖ−G(xₖ,tₖ) (29),

where yₖ is the observed measurement.

The data is edited at 610 and the observation is edited (i.e. not used) if the residual fails any of the tests given in equations 7b, 7c, 7d, 7e (above) or the statistical editing test.

At 612, the Kalman gain Kₖ is computed according to the following equation:

Kₖ=PₖHₖ^{T}[HₖPₖHₖ^{T}+Rₖ]⁻¹ (30),

where Rₖ is the measurement weight matrix that is specified at filter initialization at 602. The Rₖ parameter is a scalar in this case because the measurements are processed sequentially. The a-posteriori covariance and updated state are computed by the system 100 at 612 according to the following equations:

Pₖ=[I−KₖHₖ]Pₖ (31)

and

\hat{x}ₖ=xₖ+Kₖyₖ (32).

A determination is made at 614 as to whether further observations have occurred. If other observations occur at the same measurement time (YES at 614), then the process 600 returns to 604 and iterates until all measurements have been processed. If there are no more observations (NO at 614), the state is propagated to the next measurement time using Equation 27. Thereafter, the system 100 writes the final state to the OIC at 616 if smoothing is to be done. A determination is made at 618 as to whether smoothing is to be done. If so (YES at 618), the process 600 proceeds to 622 initialize for smoothing, and otherwise (NO at 618), the KFS algorithm 600 is finished.

If smoothing is to be done in an off-line environment where access to all measurements is possible, then a reverse filter can be used along with a forward filter. This reverse filter includes information from all measurements after the current time. A combination of the forward estimate with the backward estimate produces a smoothed estimate. The forward and reverse filters are treated identically; the filter does not know whether the state is being estimated forward in time or backward in time. The only difference is that the noise matrix Q, which is dependent on the time interval Δt, uses the value |Δt| as the argument. This is necessary to allow for noise to be continually added to the system and not be removed when Δt<0. In certain embodiments, the smoother implementation is a linear combination based solely on the diagonal elements of the covariance matrix in conjunction with the forward and backward estimates, designated by the subscripts 1 and 2, respectively. Here \hat{x}₁ and \hat{x}₂ are the two estimates and k₁ and k₂ are two arbitrary constants. The new smoothed estimate, \hat{x}, is represented by the following:

\hat{x}=k₁\hat{x}₁+k₂\hat{x}₂ (33)

For this to be an unbiased estimate, k₁+k₂=1 must be true. The constant k₁ is determined as:

$${k}_{1} = \frac{{σ}_{2}^{2}}{{σ}_{1}^{2} + {σ}_{2}^{2}} , \qquad ( 34 )$$

where σ₁² is the variance value from the forward estimate and σ₂² is the variance value from the backward estimate. The smoother of the KFS component 115 operates on the estimates as scalar values and does not include other elements of the covariance matrix. The equation of the smoother which includes the full covariance matrix is given by:

\hat{x}=[P₁⁻¹+P₂⁻¹]⁻¹[P₁⁻¹\hat{x}₁+P₂⁻¹\hat{x}₂] (35).

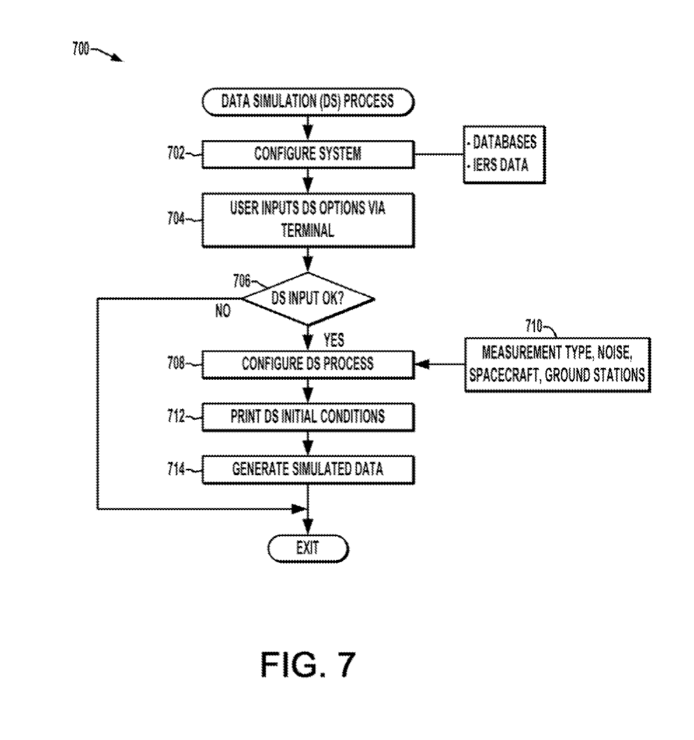

Referring now to FIG. 7, the exemplary Data Simulator (DS) component (process) 119 in FIG. 1 models all measurement types implemented in the system 100 (as shown in Table 1) except for GPS, Fence and SSN data. At 702 in FIG. 7, the simulator 119 is configured, including identification of one or more databases and provision of IERS data. At 704, the simulator 119 allows a user to input data simulation options, for example via a terminal or other user interface providing data entry to the system 100. A determination is made at 706 as to whether the received input data is correct. If so (YES at 706), the process proceeds to 708 at which the data simulation process is configured, for example, using measurement type, noise, spacecraft, and/or ground station information provided at 710. Once configured, the data simulation initial conditions are printed at 712, and the simulator 119 generates simulated data at 714.

The simulator 119 in certain embodiments prompts the user for one or more parameters, including without limitation spacecraft ID(s) and an associated ephemeris file, which is interpolated to obtain position and velocity data required for calculating the measurements, measurement type and associated ground station(s) to be used, measurement biases and random noise values, clock model parameters if time is transmitted by the spacecraft, and/or computation of measurement errors. The data simulator 119 computes the requested measurements, and in certain embodiments assumes that all errors in the simulated measurements are caused by biases and white noise. Specifically, for each measurement of each measurement type the simulator 119 computes a normally distributed pseudo-random number with a given mean (μₙ, σₙ) and standard deviation (σ), and uses that as the modeled error (in appropriate units). In general, the error for each measurement type (n) is computed by the simulator component 119 as:

eₙ=RG(μₙ,σₙ) (36),

where eₙ is the error in the measurement type, and RG is a random Gaussian. Given a modeled measurement (m₀) as computed normally by the OCEAN system routines, the simulated measurement (mₛ) is then computed as:

mₛ=m₀+eₙ (37).

The system 100 in certain embodiments also allows a user to specify parameters to be used in propagating the independent onboard spacecraft clocks. It is assumed there are 2 clocks per spacecraft: one for the precision clock and one for the GPS derived clock. The clocks are propagated assuming a random walk using an Allan variance model. Table 3 lists the parameters for the clock models:

TABLE 3
Allan variance parameters for each spacecraft clock model

| Parameter | Use |
|---|---|
| h₀ | clock bias parameter |
| hₘ₂ | clock frequency parameter |
| b₀ | initial clock bias |
| f₀ | initial frequency bias |
| fdot₀ | initial frequency bias rate |

The data simulator 119 models the time-dependent behavior of the onboard clocks as a linear growth of the clock frequency, and a quadratic growth of the clock bias, away from the starting values, upon which is superimposed a random walk away from zero using an Allan variance model.

In general, the clock and frequency biases at time t=tₖ are modeled as:

$$\begin{matrix}b ( {t}_{k} ) = {b}_{0} + {f}_{0} ( {t}_{k} - {t}_{0} ) + \frac{1}{2} {\dot{{f}_{0}} ( {t}_{k} - {t}_{0} )}^{2} + {x}_{rand} ( {t}_{k} ) & ( 38 a ) \\ f ( {t}_{k} ) = {f}_{0} + \dot{{f}_{0}} ( {t}_{k} - {t}_{0} ) + {y}_{rand} ( {t}_{k} ) & ( 38 b )\end{matrix}$$

where b₀ is the user-supplied clock bias at time t=t₀. f₀ is the user-supplied clock frequency at t=t₀, and f₀ is the user-supplied clock drift rate at t=t₀. The random walk is encapsulated in the variables X_{rand} and y_{rand}, which are also functions of time.

Compared with conventional systems, the disclosed OCEAN 100 advantageously provides additional processes, models and capabilities which increase the accuracy of parameter estimation. The new features are described in the following section. In particular, the Kalman filter smoother (KFS) component 115 allows sequential processing of measurements. Through use of the Kalman filter smoother component 115, the user may estimate the position, velocity and timing parameters of multiple space vehicles and their associated ground tracking systems. In addition, several models have been added to allow the system 100 to account for the presence of different forces acting on the space vehicles 2. These include models for space vehicle thrusting, the Earth oblateness change rate, solid Earth tides, ocean tides, indirect oblateness due to lunar gravity, general relativity accelerations, the MSIS atmosphere for aerodynamic drag, and user specified models for drag, solar radiation, albedo and spacecraft attitude. These force models are available in both the Kalman filter smoother component 115 and the weighted least squares batch component 114. Additionally, anomalistic accelerations can now be estimated by the system 100 in the WLS-OD component 114. The use of the covariance matrix has been updated to allow for a simple de-weighting scheme which allows the WLS-OD process to solve for a single pass of data.

In addition, the disclosed system 100 has the ability to ingest and process the following new measurement types: one-way range measurements; differenced one-way range measurements; differenced Global Positioning System (GPS) pseudo-range measurements; Fence data (as a direction cosines couplet); SSN data (azimuth, elevation, range and range-rate); iGPS carrier phase measurements; and proxy range-rate for iGPS carrier phase measurements. In certain embodiments, the GPS and some range measurement types are for use with the KFS process only. Other measurement types can be used with either the Kalman filter smoother process or the weighted least squares batch process, including SSN range, SSN azimuth and elevation, SSN range-rate, Fence-E/W direction cosines and/S direction cosines, GPS, and carrier phase.

The Fence data is a series of ground based radars that span across the United States and orbital bodies above 28.5 degrees inclination are detected by the system. Consisting of transmitters and receivers, the Fence system provides bearing and range with direction cosines (two different angles with respect to two different coordinate axis typically being something like east west (E/W) and north south (N/S) for detected objects. Measurements produced by the Fence are part of the SSN.

iGPS carrier phase measurements are derived from analysis of RF signals having a carrier frequency and data modulating the carrier to determine differences in received signals from two sources, and provide an indication of distance or speed by looking at a beat frequency of a known carrier phase against some reference signal. The system 100 thus provides an additional position determination assisting data source that prior OCEAN type systems did not support.

The system 100 also provides the ability to account for certain tracking measurement errors. For instance, the system 100 is able to account for space vehicle clock errors (modeled as constant, linear, or quadratic in time), one-way, two-way and three-way range measurement errors, diurnal solid Earth tide uplift for each station, offsets between a tracking antenna and the vehicle center of mass, weather effects on ionosphere radio wave propagation (evaluated using the Klobuchar ionosphere model), and plate tectonic velocity corrections for station coordinates, and the impact of tropospheric effects (assessed with the CHOI European Center for Medium Range Weather Data using either modeled or measured weather parameters). The effect of the troposphere can alternatively be accounted for using the Goad-Goodman troposphere model for radio wave propagation.

The system 100 also provides the ability to estimate the following measurement errors: one-way and three-way range biases (either on a pass-by-pass basis or over the full data arc), GPS clock biases, and differential GPS clock time, frequency, and carrier phase biases.

In addition, the data simulator 119 allows the system 100 to simulate tracking measurements in order to model position, navigation and timing determination and prediction performance.

In addition, the system 100 provides enhanced user interface features, for example, allowing an OCEAN executive software process to simplify user interaction. Additionally, a method is provided for carrier phase data to be converted to range-rate.

Table 4 shows force modeling and measurement modeling features provided by the system 100, with the table indicating whether the indicated feature can be accounted for or estimated by the orbit determination (OD) process.

TABLE 4
Features

| | Force | Measurement |
|---|---|---|
| Feature | Modeling | Modeling |
| Space vehicle thrusting | Account for | |
| | or estimate | |
| Space vehicle thrusting scale factor | estimate | |
| Earth oblateness change rate | Account for | |
| Solid Earth tides | Account for | |
| Ocean tides | Account for | |
| Lunar gravity indirect oblateness | Account for | |
| General relativity accelerations | Account for | |
| MSIS atmosphere for atmospheric | Account for | |
| drag | | |
| User-specified force model for drag | Account for/ | |
| | estimate | |
| User-specified force model for solar | Account for/ | |
| radiation pressure | estimate | |
| User-specified force model for attitude | Account for | |
| Anomalistic accelerations | Estimate | |
| One-way range measurements | | Account for |
| Differenced one-way range | | Account for |
| measurements | | |
| Differenced GPS pseudo-range | | Account for |
| measurements | | |
| Fence data (direction cosines couplet) | | Account for |
| SSN data (azimuth, elevation, range, | | Account for |
| range-rate) | | |
| iGPS carrier phase measurements | | Account for |
| Proxy range-rate for iGPS carrier | | Account for |
| phase measurements | | |
| Space vehicle GPS receiver clock | | Account for/ |
| errors | | estimate |
| One-way range measurement errors | | Account for |
| Two-way range measurement errors | | Account for |
| Three-way range measurement errors | | Account for |
| Station location error due to solid | | Account for |
| Earth tide uplift | | |
| Tracking antenna to center of mass | | Account for |
| offsets | | |
| Weather effects on ionosphere radio | | Account for |
| wave propagation (Klobuchar model) | | |
| Weather effects on troposphere radio | | Account for |
| wave propagation (CHOI model) | | |
| Weather effects on troposphere radio | | Account for |
| wave propagation (Goad-Goodman | | |
| model) | | |
| Plate tectonic velocity correction for | | Account for |
| stations | | |
| One-way pass-by-pass range biases | | Estimate |
| One-way full data arc range biases | | Estimate |
| Three-way pass-by-pass range biases | | Estimate |
| Three-way full data arc range biases | | Estimate |
| GPS clock biases | | Estimate |
| Differential GPS clock time biases | | Estimate |
| Differential GPS frequency biases | | Estimate |
| Differential GPS carrier phase biases | | Estimate |

Moreover, the system 100 provides the user with the ability to define new models, such as a user-defined force model. In previous OCEAN systems, the mathematical models for forces and measurements were fixed, with the limited ability to change the parameters at run time through the input files. The disclosed system 100 allows a user to change certain aspects of the models by supplying new code essentially at compile time. The user can also change one of the existing models. As seen in Table 4 above, several examples are listed including user-specified force models for drag, a force model for solar radiation pressure and a force model for attitude. The user compiles compile such user-defined models and the compiled user code object is then linked with the OCEAN component object(s) at link time. The linked objects then work together as one executable file executed by a processor or processors of the processing facility 10.

In accordance with further aspects of the disclosure, the system 100 is configured to estimate and refine the knowledge of spatial and temporal states of the components of a satellite system space and ground segments for the purposes of providing a terrestrial navigation accuracy (e.g. iGPS) set of information. The system 100 receives carrier phase Iridium pseudorange measurements created by one or more ground receivers that has been reformatted by an operations center, and processes the received measurements to create an updated precision position and timing estimate for a plurality of Iridium satellites. The precision estimate in certain embodiments includes an updated estimate for the position and timing of the Iridium satellites along with a high precision prediction of where the satellites will be for a given period of time forward, and the estimate update is suitable for creating orbital and timing parameters for uplinking to the Iridium constellation for re-broadcasting to Iridium augmentation service users.

The system 100 performs precision satellite position and timing using various measurements for the iGPS system that introduces new signals through the Iridium constellation to perform enhanced navigation for users. This new signal provides for better tracking through jamming and poor tracking conditions than does conventional GPS signaling. The system 100 processes an Iridium carrier phase created by a ground receiver (e.g. receiver 190) to create a precision position and time estimate for all Iridium satellites. In this regard, the operational Iridium constellation was launched to provide global communications through Iridium handsets and currently provides a position determination capability of approximately 100 meters. The precision estimate generated by using the system 100 in certain embodiments is used to create orbital and timing parameters that are uplinked to the Iridium constellation to be re-broadcast by Iridium to its users of the Iridium augmentation service.

Data is collected from Iridium satellites at several remote iGPS tracking stations. This data includes ground collected GPS signals and Iridium pseudoranges. This data is sent via a network to an Operations Center (OC) that pre-processes the data to reformat into the data required for the system 100 automatic processing. The OC then runs the system 100 on the new preprocessed data to create an updated estimate for the position and timing of the Iridium satellite and also create a high precision prediction of where the satellite will be for the next several hours. The OC runs additional software on the system 100 output to create parameters used by the user segment of iGPS. This data is transmitted back up to the Iridium satellite so it can be broadcast to users using the signals from that satellite (position and time bias). Users of the iGPS service employ a special receiver that is a combination of both GPS and Iridium measurements and parameters. This usage of the system 100 to augment the Iridium-based iGPS service provides the capability for an improved communications satellite system that has nominal orbital determination capability of approximately 100 meters for operations effectively converted into a system that has position knowledge of approximately 3 meters and corresponding velocity accuracy.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (processor-executed processes, assemblies, devices, systems, circuits, and the like), the terms (including a reference to a “means”) used to describe such components are intended to correspond, unless otherwise indicated, to any component, such as hardware, processor-executed software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A system for estimating the position, velocity and other parameters of a plurality of orbiting bodies, comprising:
at least one processor configured to compute an estimated position, velocity, and other parameters of each orbiting body of the plurality of orbiting bodies, simultaneously, at least partially by a Kalman filter smoothing process using at least one of electromagnetic and optical emissions of the orbital bodies and ground stations.

2. The system of claim 1, wherein the at least one processor is configured to compute the estimated position, velocity, and other parameters of each orbital body of the plurality of orbital bodies, simultaneously, at least partially by a weighted least squares batch estimation process using the at least one of electromagnetic and optical emissions of the orbital bodies and ground stations.

3. The system of claim 2, wherein the at least one processor is configured to compute the estimated position, velocity, and other parameters of each orbital body of the plurality of orbital bodies, simultaneously, using a de-weighting scheme of the weighted least squares batch estimation process to solve for a single pass of data.

4. The system of claim 2, wherein the at least one processor is configured to allow a user to select one or both of the Weighted Least Squares batch estimation process and the Kalman filter smoothing process to compute the estimated position, velocity, and other parameters of each orbital body of the plurality of orbital bodies.

5. The system of claim 1, comprising force models to account for different forces acting on the orbiting bodies, the force models including models for space vehicle thrusting, the Earth oblateness change rate, solid Earth tides, ocean tides, indirect oblateness due to lunar gravity, general relativity accelerations, and the MSIS atmosphere for aerodynamic drag; and
wherein the at least one processor is configured to compute the estimated position, velocity, and other parameters of each orbital body of the plurality of orbital bodies, simultaneously, at least partially according to at least one of the force models.

6. The system of claim 1, wherein the at least one processor is configured to compute estimated anomalistic accelerations for the orbital bodies.

7. The system of claim 1, wherein the at least one processor is configured to read an a-priori initial condition file to obtain an initial guess of each orbital body's position, velocity and other parameters.

8. The system of claim 1, comprising at least one user-specified model for at least one of drag, solar radiation, albedo and spacecraft attitude; and
wherein the at least one processor is configured to compute the estimated position, velocity, and other parameters of each orbital body of the plurality of orbital bodies, simultaneously, at least partially according to the at least one user-specified model.

9. The system of claim 1, wherein the at least one processor is configured to compute at least one tracking measurement error.

10. The system of claim 1, comprising a data simulator component implemented using the at least one processor, the data simulator component operative to simulate tracking measurements to model position, navigation and timing determination, and prediction performance.

11. A computer-implemented method for estimating the position, velocity and other parameters of a plurality of orbiting bodies, the method comprising:
using at least one processor, computing an estimated position, velocity, and other parameters of each orbiting body of the plurality of orbiting bodies, simultaneously, at least partially by a Kalman filter smoothing process using at least one of electromagnetic and optical emissions of the orbital bodies and ground stations.

12. The method of claim 11, comprising:
using the at least one processor, computing the estimated position, velocity, and other parameters of each orbital body of the plurality of orbital bodies, simultaneously, at least partially by a weighted least squares batch estimation process using the at least one of electromagnetic and optical emissions of the orbital bodies and ground stations.

13. The method of claim 12, comprising:
using the at least one processor, computing the estimated position, velocity, and other parameters of each orbiting body of the plurality of orbiting bodies, simultaneously, using a de-weighting scheme of the weighted least squares batch estimation process to solve for a single pass of data.

14. The method of claim 12, comprising allowing a user to select one or both of the weighted least squares batch estimation process and the Kalman filter smoothing process for computing the estimated position, velocity, and other parameters of each orbiting body of the plurality of orbital bodies.

15. The method of claim 11, comprising:
storing force models to account for different forces acting on the orbiting bodies, the force models including models for space vehicle thrusting, the Earth oblateness change rate, solid Earth tides, ocean tides, indirect oblateness due to lunar gravity, general relativity accelerations, and the MSIS atmosphere for aerodynamic drag; and
using the at least one processor, computing the estimated position, velocity, and other parameters of each orbital body of the plurality of orbital bodies, simultaneously, at least partially according to at least one of the force models.

16. The method of claim 11, comprising:
using the at least one processor, computing estimated anomalistic accelerations for the orbiting bodies.

17. The method of claim 11, comprising:
using the at least one processor, reading an a-priori initial condition file to obtain an initial guess of each orbiting body's position, velocity and other parameters.

18. The method of claim 11, comprising:
storing at least one user-specified model for at least one of drag, solar radiation, albedo and spacecraft attitude; and
using the at least one processor, computing the estimated position, velocity, and other parameters of each orbiting body of the plurality of orbital bodies, simultaneously, at least partially according to the at least one user-specified model.

19. The method of claim 11, comprising:
using the at least one processor, computing at least one tracking measurement error.

20. The method of claim 11, comprising:
using the at least one processor, simulating tracking measurements to model position, navigation and timing determination, and prediction performance.

21. A system to estimate and refine the knowledge of spatial and temporal states of the components of a satellite system space and ground segments for the purposes of providing a terrestrial navigation accuracy set of information, comprising:
at least one processor configured to compute an estimated position, velocity, and other parameters of each orbiting body of the plurality of orbiting bodies by at least one of a Kalman filter smoothing process and a weighted least squares batch estimation process using at least one of electromagnetic and optical emissions of the orbiting bodies and ground stations;
the at least one processor configured to receive a plurality of carrier phase-based Iridium pseudorange measurements created by at least one ground receiver and reformatted by an operations center; and
the at least one processor configured to process the received carrier phase based Iridium measurements to create an updated precision position and timing estimate for a plurality of Iridium satellites, the precision position and timing estimate for the plurality of Iridium satellites including an updated estimate for the position and timing of the Iridium satellites and a high precision prediction of where the satellites will be, the precision position and timing estimate being suitable for creating orbital and timing parameters for uplinking to the Iridium constellation for re-broadcasting to Iridium augmentation service users.
